(19) United States
(12) Patent Application Publication
(10) Pub. No.: US 2010/0039920 A1
(43) Pub. Date: Feb. 18, 2010

(54) IDENTIFICATION BASED PRODUCTION AND FURTHER PROCESSING METHOD OF AN OPTICAL PRODUCT, E.G. A LENS OF A MOBILE PHONE, FOR VERIFYING GENUINENESS AND TRACEABILITY OF A DEVICE WHICH INCLUDES AN OPTICAL PRODUCT

(75) Inventor: Tomi Dahlberg, Espoo (FI)

Correspondence Address: YOUNG & THOMPSON, 209 Madison Street, Suite 500, Alexandria, VA, 22314, US

(73) Assignee: PINTAVISION OY, Helsinki (FI)

(21) Appl. No.: 12/444,079

(22) PCT Filed: Oct. 2, 2007
(86) PCT No.: PCT/FI07/50533

§ 371 Date: Apr. 2, 2009

(30) Foreign Application Priority Data
Oct. 2, 2006 (FI) 20060878

(51) Int. Cl. G11B 3/70

(52) U.S. Cl. 369/273; G9B/3.103

(57) ABSTRACT

A method for producing an optical product, such as a lens of a mobile phone, wherein in the production and further processing method an identifier (2) identifying the product is achieved, by which the genuineness of the product is verifiable.

With the method according to the invention a visible or otherwise identifiable identifier identifying a device used for production and a product, is produced into an optical product, e.g. into a window protecting a display of a mobile phone, i.e. a protective lens. An individual identification is used for verifying traceability of such devices aimed at consumer markets which devices have a window protecting a display or a corresponding part for some other reason. Such products include e.g. mobile phones, PDA devices, digital cameras, portable music instruments, game consoles, watches/clocks, diving watches, pace counters, pulse meters, and other devices. Protective windows are also used in a large number of other devices and products, spectacles, protective glasses, sunglasses, domestic appliances, cars, meters, and various devices and tools including a display, used in industry, trade and services.

With an easy verification of genuineness marking of an optical product it is possible to distinguish immediately a genuine device from an illegal copy, and thus to prevent production, marketing and sales of illegal copies.

### Solutions Used Earlier:

Protective windows used as protection of mobile phone displays, and other protective windows are optical components made of plastic or other transparent material. These components are manufactured in mass production for products that are sold in consumer markets. Due to the production and further processing methods that were used earlier, an identification identifying a product has not been produced, and the genuineness of a protective window can't have been identified based on such a production and further processing method. Protective windows including a an identifying identifier have not been used earlier for verifying genuineness of products.

What has been said above concerning protective windows used for protecting displays of mobile phones also applies to other products, part of which the protective window or windows are.

Most typical production methods of the protective windows are injection moulding, and milling the protective window from a plastic plate. In neither production and further processing method there is sufficient knowledge for identifying the produced product, i.e. the protective window. For this reason protective windows cannot be identified and such an individual identifier cannot be used for verifying the genuineness of a protective window or a device.

The use of CD/DVD method for production of CD and DVD discs is meanwhile a known method including necessary knowledge. However, the CD/DVD method has not earlier been used for producing optical products like protective windows of mobile phones.

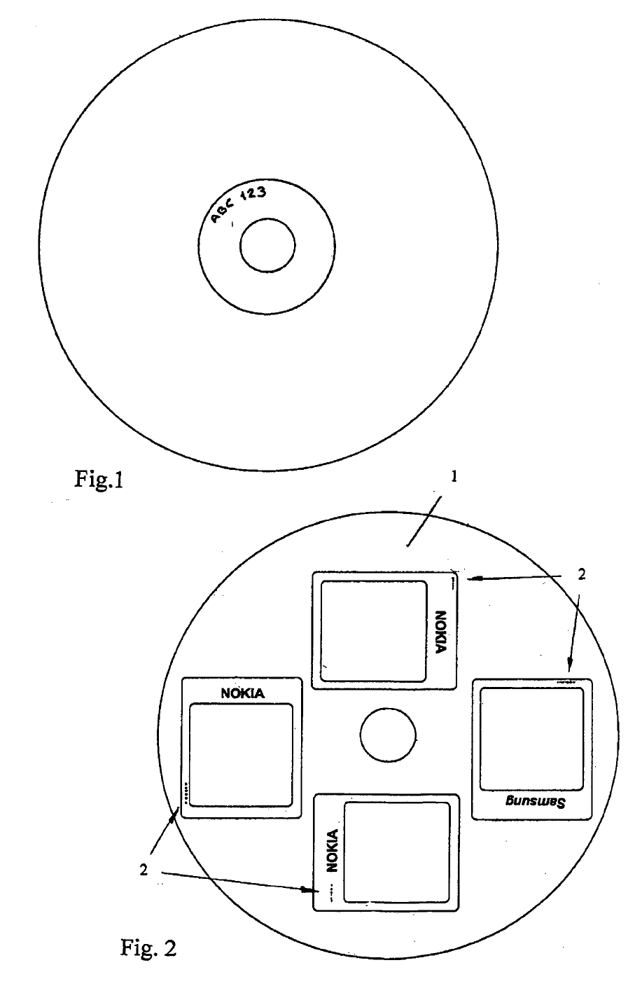

Meanwhile, in the production of CD/DVD the identifier of a device used for each CD/DVD is known. Additionally, in further processing which follows the injection moulding, each CD/DVD gets an individual identifier. This known identifier data is typically printed into inner edge of the CD/DVD (FIG. 1) and it can also be in a form of a bar code. Based on the data the identifier of the CD/DVD could also be engraved, and a further possibility is the use of a hologram.

When the CD/DVD method is used for producing protective windows by detaching the protecting windows from a preform produced with injection moulding, it is possible to print, engrave, or otherwise mark into each detached protective lens the device and the CD/DVD disc used for producing the protective lens. When the both are recorded, the individual genuineness of the protective windows can be verified by coupling the protective lens into a part of the end product.

In latest years records have been started to be made on the CD/DVD production and further processing lines in order to prevent production of illegal CD/DVD discs. An identifier identifying a CD/DVD disc is meanwhile a standard feature, by which e.g. the amount of manufactured products is controlled.

### Disadvantages of Earlier Solutions:

An earlier production and further processing method for identification based production of an optical product meant in this application has not been developed. A disadvantage of an optical product therefore has been that their genuineness can't have been verified, and the genuineness of a product can't have been verified with the optical product.

### Functional and Structural Characteristics of the Solution According to the Invention:

When the preform of the protective windows has been injection moulded with an injection moulding device, and it is transferred further in the further processing, the identifier in the storage of the further processing equipment is printed, engraved or marked in other way into each protective window, which is later cut off.

The identifier can also be marked with material conducting radio signal or electricity. Thereby it is possible to develop a functionality in mobile phones and electronic devices by which the conservation of the genuineness can be verified. If someone would succeed in changing a protective window without having a marking in the changed protective window, the mobile phone or an electronic device would not then work at all.

The characteristics of the method according to the invention are described in the characteristics of the patent claims of the patent claim constellation.

### Advantages of the Solution According to the Invention:

Product piracy, illegal copying and illegal production which breaks mark protection are a significant problem and their prevention causes significant costs for the producers.

An inexpensive production and further processing method based on individual identification has not been available for verifying genuineness. The invention has production technological inexpensiveness as its advantage.

The invention is described in the following by citing the enclosed drawing wherein

FIG. 1 illustrates a CD/DVD disc provided with identification information known as such, and

FIG. 2 illustrates a CD/DVD disc preform, which has optical protective lenses for mobile phone, which lenses can be cut off.

The products according to the invention, in this example protective lenses, are produced with CD/DVD production technology, as described in e.g. patent application FI 20020239. For example, in connection with metallising a CD/DVD disc preform 1, into each protective lens the same identifier 2 is achieved, such as a bar code, which varies in every disc preform to be metallised. After the protective lens has been cut off and attached to a cover of a mobile phone, the bar code is visible in each mobile phone in such a way that it is readable with an optical reading device, such as a laser reading device, but it is not visible in a disturbing manner.

The identifier can also be made into protective lenses within a disc preform with a laser marking device, in such a way that each protective lens has an own identifier which differs from other identifiers. If camera vision of the process detects already during the process that some product has a fault, then in the end part of the process, where the protective lenses are cut off from the disc preform, this faulty piece remains uncut, it moves to disposal together with the waste part and does not come out of the process as a protective lens.

The identifier is made into such a location of the protective lens that it is readable when the protective lens is attached to the cover of a mobile phone. The protective lens of a mobile phone, the cover of a mobile phone, and the genuineness and the traceability of a mobile phone can thus be identified with this new invention- in an easy and sure manner.

1. A method for producing an optical product, such as a lens of a mobile phone, characterised in that in the production and further processing method of the product a CD/DVD disc preform (1) is produced, including at least one product, an identifying identifier (2) is achieved, by which the genuineness and traceability of the product can be verified, and in which method the product is cut off from the CD/DVD disc preform.

2. A method according to claim 1, characterised in that the identifier (2) is achieved with a mark, which is in a casting mould.

3. A method according to claim 1, characterised in that the identifier (2) is achieved in connection with metallising the CD/DVD disc preform in such a way that each product to be cut off obtains its own identifier.

4. A method according to claim 1, characterised in that the identifier (2) variable in such a way that each CD/DVD disc preform has a variable series of numbers, bar code or other variable identifier, but in each product of a CD/DVD disc preform the identifier is the same.

5. A method according to claim 1, characterised in that the identifier (2) is achieved in connection with colour printing of the CD/DVD disc preform.

6. A method according to claim 1, characterised in that the identifier (2) is formed of letters/numbers.

7. A method according to claim 1, characterised in that the identifier (2) is formed of a bar code.

8. A method according to claim 1, characterised in that the identifier (2) is formed of a hologram.

9. A method according to claim 1, characterised in that the identifier (2) is formed of an engraving.

10. A method according to claim 1, characterised in that the identifier (2) is formed of material which conducts radio signal or electricity.

11. A method according to claim 1, characterised in that the identifier (2) is achieved into a product with a laser marking device.

12. A method according to claim 1, characterised in that the identifier (2) is achieved into a frame of a product, such as into a metallising.

13. A method according to claim 1, characterised in that the identifier (2) is achieved into a transparent window of a product.

14. A method according to claim 1, characterised in that the identifier (2) is achieved so small and unnoticable that it is readable only with a magnifying glass, a microscope or camera sight.

15. A method according to claim 2, characterised in that the identifier (2) is achieved in connection with metallising the CD/DVD disc preform in such a way that each product to be cut off obtains its own identifier.

16. A method according to claim 2, characterised in that the identifier (2) variable in such a way that each CD/DVD disc preform has a variable series of numbers, bar code or other variable identifier, but in each product of a CD/DVD disc preform the identifier is the same.
